(19) United States
(12) Patent Application Publication
(10) Pub. No.: US 2006/0017775 A1
(43) Pub. Date: Jan. 26, 2006

(54) Substrate structure for forming an alignment film thereon by ink-jet printing and liquid crystal panel formed by using the same

(75) Inventors: Huai-An Li, Tao Yuan City (TW); Sheng-Song Chang, Yang Mei Town (TW); Ching-Chun Chien, Ta Hsi Town (TW)

Correspondence Address: BIRCH STEWART KOLASCH & BIRCH, PO BOX 747, FALLS CHURCH, VA, 22040-0747, US

(73) Assignee: Chunghwa Picture Tubes., Ltd, Taipei (TW)

(21) Appl. No.: 11/183,935

(22) Filed: Jul. 19, 2005

(30) Foreign Application Priority Data
Jul. 19, 2004 (TW) 93121534

(51) Int. Cl. B41J 2/135

(52) U.S. Cl. 347/45

(57) ABSTRACT

A substrate structure for forming an alignment film thereon is described, which includes a substrate and an adjusting unit formed on a non-display area of the substrate. Further, the adjusting unit is composed of a bump, a groove, or a combination thereof. When an alignment agent is ink-jet printed, the bump is used to prevent the alignment agent from spreading over a sealing area of the substrate, and the groove is engaged in receiving the superfluous alignment agent. Therefore, the size of the alignment film is confined and the uniformity of the alignment film is greatly improved.

### RELATED APPLICATIONS

The present application is based on, and claims priority from, Taiwan Application Serial Number 93121534, filed Jul. 19, 2004, the disclosure of which is hereby incorporated by reference herein in its entirety.

### FIELD OF THE INVENTION

The present invention relates to a mechanism for forming an alignment film, and more particularly, to a substrate structure for forming an alignment film thereon by ink-jet printing and a liquid crystal panel formed by using the same.

### BACKGROUND OF THE INVENTION

Alignment films are key components for the control of the display quality of a liquid crystal display (LCD) and are respectively deposed on an upper and a lower indium tin oxide (ITO) transparent electrode in a liquid crystal cell, to control the arrangement directions of liquid crystal elements and to provide pretilt angles required by various LCD structures. The alignment film is typically composed of polyimide (PI) which has properties of high heat resistance, high chemical solvent resistance, high radiation resistance and superior insulation.

A conventional method for forming an alignment film uses a screen printing technique, in which the ITO transparent electrode is coated with an alignment agent and then baked to remove all traces of solvent and water, so as to leave an alignment film. The alignment film is rubbed along a fixed direction by using nylon or artificial silk, so as to make the liquid crystals in the liquid crystal cell arrange along a fixed direction. However, in the screen printing technique, the effective utility rate of the alignment agent is low, and the method for exchanging the material species is complicated and time-consuming. Therefore, an ink-jet printing method has been developed to fabricate an alignment film.

In the ink-jet printing technique, an alignment agent is dispensed on an ITO electrode by using an ink-jet head and a nozzle, in which the dispensing procedure may be performed repeatedly for obtaining a planar alignment film, and is followed by a drying step and a rubbing step. The viscosity of the alignment agent used in the ink-jet printing technique is low, so it is difficult to control the spreading of the edge of the alignment film. As a result, the edge of the film is uneven, and the size of the film is difficult to control. When the alignment film passes the seal area, the seal intensity is lowered to degrade the seal quality. Moreover, the alignment agent dries inward from the edge and is gradually pushed outward from the center, so that the edge region is thicker than the central region of the alignment film. The non-uniform thickness of the alignment film easily causes a non-uniform alignment issue, which degrades the display quality.

### SUMMARY OF THE INVENTION

Therefore, one objective of the present invention is to provide a substrate structure for forming an alignment film thereon by ink-jet printing, to control the area and the size of the ink-jet printed alignment film and to solve the problems of unevenness and inequality occurring at the edge of the alignment film.

According to the aforementioned objectives, an aspect of the present invention provides an alignment film substrate structure with a bump formed thereon, which can effectively control the scope and the size of the ink-jet printed area of the alignment film, so as to make the alignment film formed within the seal area.

According to a preferred embodiment of the present invention, at least one bump is deposited on a non-display area to prevent an alignment film from diffusing inappropriately, so as to prevent the alignment film from passing over a seal area to decrease the intensity of the seal. The ratio of a height of the bump to the gap between an upper substrate and a lower substrate is between about 1:2 and 1:50, which is preferably between about 1:1 and 1:3, and is more preferably about 1:2.

Another aspect of the present invention provides an alignment film substrate structure with a groove formed therein, which can effectively control the thickness of the edge of the alignment film, so as to prevent the edge of the alignment film from being thicker than the center of the alignment film, conforming with the thickness uniformity requirement.

According to another preferred embodiment of the present invention, the at least one groove is formed in a non-display area for receiving the superfluous alignment agent, which can decrease a thickness of the edge of the alignment film, so that the issue that the edge of the alignment film has a larger thickness can be avoided. A depth of the groove may be modified according to the process requirements and the ink-jet printing frequency.

According to still another preferred embodiment of the present invention, at least one composition structure is deposed on a non-display area, in which the composition structure is composed of a bump and a groove. When an alignment agent is ink-jet printed, the bump is used to prevent the alignment agent from spreading over a sealing area of the substrate, and the groove is engaged in receiving the superfluous alignment agent. Therefore, the area of the alignment film is confined and the uniformity of the alignment film is greatly improved. Therefore, the scope and the size of the ink-jet printed area of the alignment film can be effectively controlled, and the thickness of the edge of the alignment film can be decreased to obtain an alignment film having an even edge and a uniform thickness.

According to the aforementioned description, with the application of the substrate structure for forming an alignment film thereon by an ink-jet printing of the present invention, the area covered by the ink-jet printed alignment film can be effectively controlled, and can avoid the issue that the edge of the alignment film has a larger thickness, thereby obtaining an alignment film of a precise size and a uniform thickness.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a lateral view showing an alignment film substrate structure with a bump formed thereon in accordance with a preferred embodiment of the present invention;

FIG. 2 is a lateral view showing an alignment film substrate structure with a groove formed thereon in accordance with another preferred embodiment of the present invention;

FIG. 3 is a lateral view showing an alignment film substrate structure in accordance with still another preferred embodiment of the present invention;

FIG. 4 is a lateral view showing a combination structure composed of an upper substrate having a bump formed thereon and a lower substrate having a bump formed thereon; and

FIG. 5 is a lateral view showing a combination structure composed of an upper substrate having a combination structure formed thereon and a lower substrate having a combination structure formed thereon.

### DETAILED DESCRIPTION OF THE PREFERRED EMBODIMENT

The preferred embodiments of a substrate structure for forming an alignment film thereon by ink-jet printing in the present invention are stated with reference to the attached drawings.

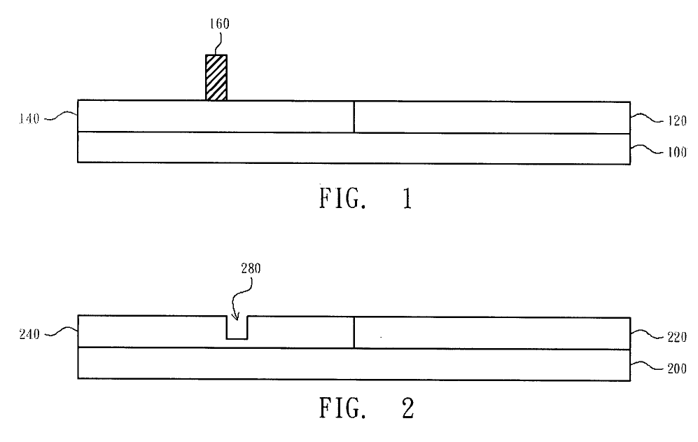

After a substrate is bonded with an indium tin oxide conductive material layer, an alignment film is formed on a surface of the ITO conductive material layer by ink-jet printing. FIG. 1 is a lateral view showing an alignment film substrate structure with a bump formed thereon in accordance with a preferred embodiment of the present invention. A substrate 100 is divided into a display area 120 and a non-display area, in which the non-display area is a seal area 140. The ink-jet printing technique is to dispense an alignment agent on the substrate 100, and to confine the alignment agent to the seal area 140. In the present invention, a bump 160 is used as an adjusting unit and is deposed on the seal area 140 to prevent the alignment agent from spreading over the seal area 140 and reducing the seal integrity when the alignment agent is dispensed. Accordingly, with the installation of the bump 160, the scope and the size of the ink-jet printed area of the alignment film can be exactly controlled, which can confine the alignment film within the seal area 140.

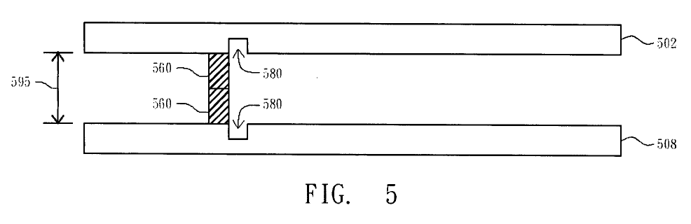

The bump 160 may be located anywhere on the seal area 140, and is preferably located between one-third and one-half of the seal area width. Referring to FIG. 4, when a display area of an upper substrate 402 and a display area of a lower substrate 408 are combined oppositely to form a liquid crystal panel, bumps 460 are used for aligning the upper substrate 402 and the lower substrate 408 and for precisely controlling the seal. A height of the bump 460 is between about one-fiftieth width of a gap 495, which is between the upper substrate 402 and the lower substrate 408, and about one width of the gap 495; and is preferably between about one width of the gap 495 and about one-third width of the gap 495, and is more preferably about one-half width of the gap 495 (such as shown in FIG. 4). Various materials may be selected to manufacture the bump 160 according to different processes. For example, when a thin-film transistor array process is performed, ITO, Cr, CrO, Cu, Al, Al₂O₃, SiNₓ, SiO₂ or any combination thereof is used to manufacture the bump 160; when a color filter (CF) process is performed, resin, Cr, CrO or any combination thereof is used to manufacture the bump 160.

With the application of the alignment film substrate structure with the bump formed thereon of the present embodiment, the size of the alignment film can be effectively confined, so the present embodiment is particularly suitable to a multi-domain vertical alignment liquid crystal display, which does not need an alignment process.

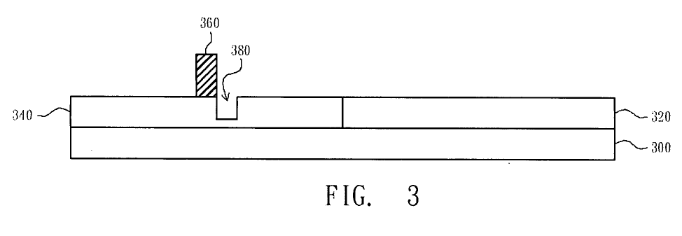

FIG. 2 is a lateral view showing an alignment film substrate structure with a groove formed thereon in accordance with another preferred embodiment of the present invention. A transparent conductive material layer has been formed on a substrate 200, which is divided into a display area 220 and a non-display area, such as a seal area 240. The seal area 240 further includes a groove 280 formed thereon for adjusting the alignment film. When an alignment agent is ink-jet printed over a surface of the display area 220 and a surface of the seal area 240, the groove 280 is engaged in receiving the superfluous alignment agent. Accordingly, while the alignment agent pushes outward in drying, the superfluous alignment agent flows into the groove 280 to reduce a thickness of the alignment film edge, so that the issue of the edge of the alignment film being thicker can be solved to obtain an alignment film with an even edge and uniform thickness.

A depth of the groove 280 may be modified according to the process requirements and the ink-jet printing frequency; and the groove 280 may be deposed anywhere on the seal area 240, and is preferably located between one-third and one-half of the width of the seal area 240.

With the application of the present embodiment, an alignment film with uniform thickness can be obtained, so the alignment film substrate structure with the groove formed thereon of the present embodiment is particularly suitable to a twisted nematic (TN) liquid crystal display or a super twisted nematic (STN) liquid crystal display, which needs a stricter alignment process.

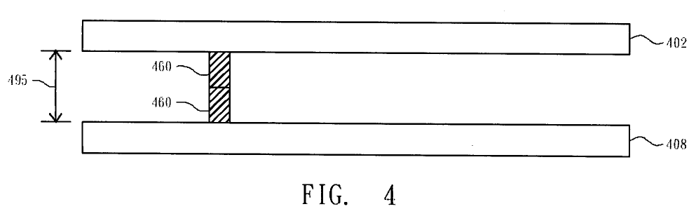

Still another preferred embodiment of the present invention is to combine the bump and the groove described above to form a combination structure as an adjusting unit. Referring to FIG. 3, a substrate 300 has been divided into a display area 320 and a non-display area, such as a seal area 340, surrounding and adjacent to the display area 320. A bump 360 and a groove 380 are formed on the seal area 340, in which the groove 380 is deposed at an inner side of the bump 360. When an alignment agent is ink-jet printed over a surface of the display area 320 and a surface of the seal area 340, the groove 380 receives the superfluous alignment agent, and the bump 360 prevents the alignment agent from going beyond the seal area 340 to degrade the seal intensity. Therefore, the area scope and the size of the alignment film can be effectively controlled, and the edge of the alignment film can thereby be even and uniformly thick.

In the fabrication of a liquid crystal panel, bumps 360 may be used for aligning an upper substrate and a lower substrate. Referring to FIGS. 3 and 5, an upper substrate 502 and a lower substrate 508 both have an adjusting unit composed of a combination structure including a bump 560 and a groove 580. The sum of the heights of the two bumps 560 is equal to a gap 595 between the upper substrate 502 and the lower substrate 508. The ratio of the height of the bump 560 to the gap 595 between the upper substrate 502 and the lower substrate 508 is between about 1:1 and about 1:50, is preferably between about 1:1 and about 1:3, and is more preferably about 1:2. The bump 560 may be composed of various materials, such as ITO, resin, Cr, CrO, Al, Al₂O₃, Cu, SiNe, SiO₂ or any composition thereof. The combination structure may be deposed anywhere on the seal area 340 and is preferably located between one-third and one-half of the width of the seal area 340. The present embodiment may be suitable for an MVA liquid crystal display, a TN liquid crystal display or an STN liquid crystal display.

Furthermore, a plurality of bumps, grooves or the combination structures thereof may be formed on a substrate to form a substrate structure for forming an alignment film thereon, which can more effectively control the size of the alignment film and the film edge uniformity. Accordingly, with the application of the substrate structure of the present invention, the scope of the ink-jet printed area of the alignment film and the film edge flatness can be controlled no matter what kind of alignment film is used or how many times the film is ink-jet printed. Therefore, the size of the alignment film and the thickness uniformity of the film can be effectively controlled.

According to the aforementioned description, with the application of the substrate structure for forming an alignment film thereon by ink-jet printing, the alignment agent can be prevented from spreading over a sealing area of the substrate or the superfluous alignment agent can be received, so as to form an alignment film within the seal area, to maintain the intensity of the seal, and to accurately control the size of the alignment film and reduce the thickness of the edge, to thereby obtain an alignment film with an even edge and a uniform thickness.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A substrate structure for forming an alignment film thereon by an ink-jet printing method, comprising:
a substrate including a display area and a non-display area, wherein the non-display area is surrounding and adjacent to the display area; and
at least one adjusting unit deposed on the non-display area to confine a size of an alignment film on the substrate.

2. The substrate structure for forming an alignment film thereon by an ink-jet printing method according to claim 1, wherein the at least one adjusting unit is a bump.

3. The substrate structure for forming an alignment film thereon by an ink-jet printing method according to claim 2, wherein the bump is selected from the group consisting of indium tin oxide (ITO), Cr, CrO, Cu, Al, Al₂O₃, SiNₓ, SiO₂, resin and any combination thereof.

4. The substrate structure for forming an alignment film thereon by an ink-jet printing method according to claim 2, wherein the substrate is apart from another substrate by a distance, and the ratio of a height of the bump to the distance is between 1:1 and 1:50.

5. The substrate structure for forming an alignment film thereon by an ink-jet printing method according to claim 2, wherein the substrate is apart from another substrate by a distance, and the ratio of a height of the bump to the distance is between 1:1 and 1:3.

6. The substrate structure for forming an alignment film thereon by an ink-jet printing method according to claim 2, wherein the substrate is apart from another substrate by a distance, and the ratio of a height of the bump to the distance is 1:2.

7. The substrate structure for forming an alignment film thereon by an ink-jet printing method according to claim 1, wherein the at least one adjusting unit is a groove.

8. The substrate structure for forming an alignment film thereon by an ink-jet printing method according to claim 1, wherein the at least one adjusting unit further comprises:
a bump; and
a groove deposed at an inner side of the bump.

9. The substrate structure for forming an alignment film thereon by an ink-jet printing method according to claim 8, wherein the bump is selected from the group consisting of ITO, Cr, CrO, Cu, Al, Al₂O₃, SiNe, SiO₂, resin and any combination thereof.

10. The substrate structure for forming an alignment film thereon by an ink-jet printing method according to claim 8, wherein the substrate is apart from another substrate by a distance, and the ratio of a height of the bump to the distance is between 1:1 and 1:50.

11. The substrate structure for forming an alignment film thereon by an ink-jet printing method according to claim 8, wherein the substrate is apart from another substrate by a distance, and the ratio of a height of the bump to the distance is between 1:1 and 1:3.

12. The substrate structure for forming an alignment film thereon by an ink-jet printing method according to claim 8, wherein the substrate is apart from another substrate by a distance, and the ratio of a height of the bump to the distance is 1:2.

13. An alignment film substrate structure, which is applied in an ink-jet printing technique, and the alignment film substrate structure comprising:
a substrate;
a seal area deposed on the substrate; and
at least one adjusting unit deposed at a location between one-third and one-half of a width of the seal area, to confine a scope of the alignment film.

14. The alignment film substrate structure according to claim 13, wherein the adjusting unit is composed of a bump, a groove, or a combination thereof.

15. The alignment film substrate structure according to claim 14, wherein the bump is selected from the group consisting of ITO, Cr, CrO, Cu, Al, Al₂O₃, SiNₓ, SiO₂, resin and any combination thereof.

16. The alignment film substrate structure according to claim 14, wherein the substrate is apart from another substrate by a distance, and the ratio of a height of the bump to the distance is between 1:1 and 1:50.

17. The alignment film substrate structure according to claim 14, wherein the substrate is apart from another substrate by a distance, and the ratio of a height of the bump to the distance is between 1:1 and 1:3.

18. The alignment film substrate structure according to claim 14, wherein the substrate is apart from another substrate by a distance, and the ratio of a height of the bump to the distance is 1:2.

19. A liquid crystal panel, comprising:
a first substrate including a first display area and a first non-display area surrounding and adjacent to the first display area;
a first adjusting unit deposed on the first non-display area;
a second substrate including a second display area and a second non-display area surrounding and adjacent to the second display area, wherein the second display area corresponds to the first display area; and
a second adjusting unit deposed on the second non-display area and corresponding to the first adjusting unit.

20. The liquid crystal panel according to claim 19, wherein the adjusting unit is composed of a bump, a groove, or a combination thereof.

21. The liquid crystal panel according to claim 20, wherein the bump is selected from the group consisting of ITO, Cr, CrO, Cu, Al, Al₂O₃, SiNₓ, SiO₂, resin and any combination thereof.

22. The liquid crystal panel according to claim 19, wherein the sum of a height of the first adjusting unit and a height of the second adjusting unit are equal to a gap between the first substrate and the second substrate.

23. The liquid crystal panel according to claim 22, wherein each of the height of the first adjusting unit and the height of the second adjusting unit is one-half of the gap.

24. The liquid crystal panel according to claim 19, wherein the first adjusting unit and the second adjusting unit are composed of the same bump.

25. The liquid crystal panel according to claim 19, wherein the first adjusting unit and the second adjusting unit are similarly composed of a combination structure including a bump and a groove.
